(19) United States
(12) Patent Application Publication
(10) Pub. No.: US 2011/0034328 A1
(43) Pub. Date: Feb. 10, 2011

(54) Double Metal-Carbon Nanotube Hybrid Catalyst and Method for Preparation Thereof

(76) Inventors: Jeung-Ku Kang, Daejeon (KR); Weon-Ho Shin, Daejeon (KR); Hyung-Mo Jeong, Daejeon (KR); Yoon-Jeong Choi, Daejeon (KR)

Correspondence Address: TIPS GROUP;c/o Intellevate LLC, P. O. BOX 52050, Minneapolis, MN, 55402, US

(21) Appl. No.: 12/777,180

(22) Filed: May 10, 2010

(30) Foreign Application Priority Data
Aug. 5, 2009 (KR) 10-2009-0072165

(51) Int. Cl. B01J 21/18; B01J 23/755; B01J 23/42

(52) U.S. Cl. 502/185; 977/742; 977/775

(57) ABSTRACT

Disclosed are a double metal-carbon nanotube hybrid catalyst comprising at least two of transition metals selected from a group consisting of Mn, Fe, Co, Ni, Cu, Mo, Tc, Ru, Rh, Pd, Ag, Re, Os, Ir and Pt which are distributed in the catalyst. The double metal-carbon nanotube hybrid catalyst contains at least two different transition metals with high catalytic activity and may generate hydrogen from an aqueous ammonia-borane (NH₃BH₃) solution at a high speed and a method for preparation of a double metal-carbon nanotube hybrid catalyst.

This application claims priority to Korean Patent Application No. 2009-0072165, filed on Aug. 5, 2009, in the Korean Intellectual Property Office, the entire contents of which are hereby incorporated by reference.

### BACKGROUND OF THE INVENTION

1. Field of the Invention

The present invention relates to a double metal-carbon nanotube hybrid catalyst capable of generating hydrogen from an ammonia-borane (NH₃BH₃) solution at a high speed, and a method for preparation thereof.

2. Description of the Related Art

A carbon nanotube is well known with much attention as a material having excellent thermal, mechanical and electric properties useful for a variety of applications. Especially, a carbon nanotube having a transition metal attached thereto shows improved material characteristics and/or may be used as a hybrid substance enabling expression of additional characteristics.

An example of currently employed catalysts for hydrogen generation is a noble metal-carbon nanotube hybrid catalyst containing only one noble metal such as Pt, Ru, etc., as disclosed in S. C. Amendola et al., Power Sources 25, 269, 2000; and C. Wu, H. M. Zhang et al., Catal. Today 93-95, 477, 2004. However, such a hybrid catalyst requires a complicated manufacturing process and has difficulty in mass-production, therefore, entails restrictions in time and economic aspects in view of practical application.

Meanwhile, a transition metal-carbon nanotube hybrid catalyst containing a single transition metal such as Co or Ni being relatively cheaper than noble metals such as Pt or Ru was proposed in G. G. Wildgoose et al., Small, 2, 182, 2006. However, this catalyst also has problems of low catalytic activity due to limited contact area between the transition metal-carbon nanotube hybrid catalyst and NH₃BH₃, although the foregoing hybrid catalyst comprises nano-scale particles.

### SUMMARY OF THE INVENTION

Accordingly, it is an object of the present invention to provide a double metal-carbon nanotube hybrid catalyst with high speed hydrogen generation from an aqueous ammonia-borane (NH₃BH₃) solution and economic merit, and a method for preparation of the same.

In order to accomplish the above object, the present invention provides a method for preparation of a double metal-carbon nanotube hybrid catalyst comprising: adding nitrogen doped carbon nanotube (NDCNT) to a polyol solution to prepare a carbon nanotube solution; adding at least two of transition metal salts as well as sodium borohydride (NaBH₄) to the prepared carbon nanotube solution to return the carbon nanotube by reduction thereof; and thermally treating the reduced carbon nanotube under hydrogen atmosphere after vacuum drying the same, so as to form the double metal-carbon nanotube hybrid catalyst.

The double metal-carbon nanotube hybrid catalyst of the present invention comprises carbon nantoubes with excellent electrical conductivity and at least two different transition metals functioning as a reactant, thus exhibiting improved catalytic activity. Accordingly, the inventive double metal-carbon nanotube hybrid catalyst containing at least two different transition metals may have higher hydrogen generation efficiency relative to the same mass, compared to a double metal-carbon nanotube hybrid catalyst comprising only one transition metal.

Also, the inventive double metal-carbon nanotube hybrid catalyst which enables generation of high capacity hydrogen from an aqueous NH₃BH₃ solution may store hydrogen in a simple mode, compared to conventional storage methods such as high pressure gas storage, liquefaction and storage, hydrogen storage using hydrogen storage alloys, etc. and, in addition, have advantages such as scale-down of hydrogen storage tank owing to high hydrogen storage capacity, reduction in investment costs, and the like.

Therefore, the double metal-carbon nanotube hybrid catalyst according to the present invention may be widely applied in different industrial fields using hydrogen energy including, for example, hydrogen storage systems for fuel cell, fuel storage systems for a hydrogen fuel cell vehicle, electric car, power sources for small electronic devices, and so forth.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a TEM photograph showing a Ni_{0.72}Pt_{0.28}-carbon nanotube hybrid catalyst prepared in Preparative Example 2;

FIG. 2 is a HRTEM photograph showing the Ni_{0.72}Pt_{0.28}-carbon nanotube hybrid catalyst prepared in Preparative Example 2;

FIG. 3 illustrates lattice points obtained by Fourier transformation of a transition metal lattice of the Ni_{0.72}Pt_{0.28}-carbon nanotube hybrid catalyst prepared in Preparative Example 2;

FIG. 4 is a graph for comparatively illustrating an amount of hydrogen generated per minute from an aqueous NH₃BH₃ solution by the Ni_{0.72}Pt_{0.28}-carbon nanotube hybrid catalyst prepared in Preparative Example 2 relative to a target amount of hydrogen generated per minute according to US Department of Energy (DOE);

FIG. 5 is a graph for illustrating a speed of generating hydrogen from an aqueous NH₃BH₃ solution by the Ni_{0.72}Pt_{0.28}-carbon nanotube hybrid catalyst prepared in Preparative Example 2 depending on temperature;

FIG. 6 illustrates an Arrhenius plot drawn up based on hydrogen generation characteristics of the Ni_{0.72}Pt_{0.28}-carbon nanotube hybrid catalyst prepared in Preparative Example 2 depending on temperature;

FIG. 7 is an X-ray diffraction analysis photograph illustrating double metal-carbon nanotube hybrid catalysts of the present invention and transition metal-carbon nanotube hybrid catalysts as controls according to Comparative Example 1; and

FIG. 8 is a graph illustrating a speed of generating hydrogen from an aqueous NH₃BH₃ solution by each of the inventive double metal-carbon nanotube hybrid catalysts and the foregoing transition metal-carbon nanotube hybrid catalysts as controls prepared in Comparative Example 1, according to Comparative Example 2.

### DETAILED DESCRIPTION OF THE INVENTION

According to an aspect of the present invention, there is provided a double metal-carbon nanotube hybrid catalyst comprising at least two transition metals selected from a group consisting of Mn, Fe, Co, Ni, Cu, Mo, Tc, Ru, Rh, Pd, Ag, Re, Os, Ir and Pt, which are homogeneously distributed in the catalyst. The double metal-carbon nanotube hybrid catalyst includes nitrogen with high chemical activity as a heterogeneous element added to carbon nanotubes and comprises at least two different transition metals with high catalytic activity and a nano-scale size uniformly distributed in the carbon nanotubes, so as to generate hydrogen from an aqueous ammonia-borane (NH₃BH₃) solution at a high speed.

According to another aspect of the present invention, there is provided a method for preparation of a double metal-carbon nanotube hybrid catalyst comprising: adding nitrogen doped carbon nanotube (NDCNT) to a polyol solution to prepare a carbon nanotube solution; adding at least two of transition metal salts as well as NaBH₄ to the prepared carbon nanotube solution to return the carbon nanotube by reduction thereof; and thermally treating the reduced carbon nanotube under a hydrogen atmosphere after vacuum drying the same, so as to form the double metal-carbon nanotube hybrid catalyst. The foregoing NaBH₄ as a reductant.

The NDCNT is preferably prepared by plasma chemical vapor deposition (CVD) using a gas mixture containing a hydrocarbon gas and a nitrogen gas in a ratio (%) by volume of 1:99 to 99:1 in the presence of a metal catalyst. When the hydrocarbon gas and the nitrogen gas are separately introduced into the metal catalyst, a relative ratio thereof may range from 1:99 to 99:1. On the other hand, if a mixture of the hydrocarbon gas and nitrogen gas is used, the relative ratio thereof may range from 10:90 to 90:10.

The metal catalyst includes cobalt (Co), iron (Fe), nickel (Ni), or a compound containing the same, however, is not particularly limited thereto so long as it may facilitate a catalytic reaction during preparation of NDCNT.

The plasma CVD may be performed using a microwave, RF or DC power source as a plasma generating source.

Preferably, the NDCNT is a carbon nanotube containing nitrogen in the range of 0.1 to 20 at % (atomic percentage).

The polyol may include at least one selected from a group consisting of ethyleneglycol, diethyleneglycol, polyethyleneglycol, 1,2-propanediol and dodecanediol alone or in combination with two or more thereof.

A transition metal in the transition metal salt may be at least one selected from a group consisting of Mn, Fe, Co, Ni, Cu, Mo, Tc, Ru, Rh, Pd, Ag, Re, Os, Ir and Pt.

Preferably, anions contained in the transition metal salt are acetate or chloride.

Hereinafter, the present invention will be described in greater detail with reference to the following preparative examples, experimental examples and comparative examples. However, these examples are intended for illustrative purposes and it would be appreciated by a person skilled in the art that various modifications and variations may be made without departing from the scope of the present invention. Therefore, it is not construed that the present invention is restricted to such examples.

### EXAMPLES

### Preparative Example 1

### Growth of Nitrogen Doped Carbon Nanotube (NDCNT)

Before preparation of NDCNT, a catalyst for growing the NDCNT was prepared by magnetron RF sputtering method. A process of preparing the catalyst for growth of NDCNT will be described in detail below.

Under an argon atmosphere of 15 torr, Fe was deposited on a SiO₂/Si substrate. RF power used for deposition was set to 100 W and a thickness of Fe deposition was 10 nm. In order to form Fe particles from an Fe layer deposited on the substrate, plasma processing was carried out using a microwave enhanced CVD apparatus at a microwave power of 700 W for 1 minute.

Fe particles deposited on the substrate fabricated during the foregoing processes may be used as a catalyst for growth of NDCNT.

The catalyst for growing NDCNT was placed in a chamber, a hydrocarbon gas and a nitrogen gas were mixed in a ratio by volume of 15:85 and introduced into the chamber, followed by executing plasma CVD reaction. The chamber was maintained at 700° C. with a pressure of 21 torr. The plasma CVD reaction was performed with a microwave power of 800 W for 20 minutes, resulting in formation of the NDCNT.

### Preparative Example 2

### Double Metal-Carbon Nanotube Hybrid Catalyst

Adding 10 mg of the NDCNT formed in Preparative Example 1 to 300 mL of ethyleneglycol solution, ultrasonic homogenization was performed to prepare a carbon nanotube solution.

After adding two different transition metal salts, that is, 7 mL of 10 mM NiCl₂.4H₂O and 1 mL of 10 mM H₂PtCl₆.4H₂O to the prepared carbon nanotube solution, 100 mL of 0.1M NaBH₄ as a reductant was further added to the mixture. From results of Inductive Coupled Plasma analysis for the above transition metal salts, it was found that a ratio by volume of the transition metal salts is defined by Ni:Pt=0.72:0.28. Therefore, a transition metal composite with such ratio will be referred to as Ni_{0.72}Pt_{0.28}.

After filtering the carbon nanotube solution containing the transition metal salts and NaBH₄, the filtered material was sufficiently washed with acetone to obtain a pure product. The pure product was vacuum dried and thermally treated at 300° C. under a hydrogen atmosphere after vacuum drying at 60° C., thereby completing formation of a Ni_{0.72}Pt_{0.28}-carbon nanotube hybrid catalyst according to the present invention.

FIG. 1 is a TEM photograph showing the inventive Ni_{0.72}Pt_{0.28}-carbon nanotube hybrid catalyst. Referring to FIG. 1, it can be seen that the Ni_{0.72}Pt_{0.28} transition metal is homogeneously distributed in the carbon nanotube and a size thereof is substantially uniform.

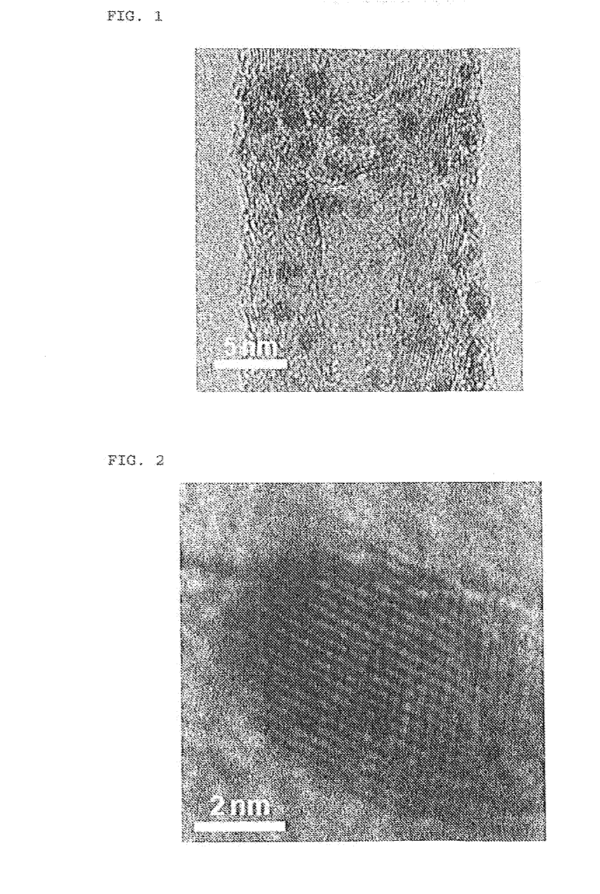

FIG. 2 is a HRTEM photograph showing the inventive Ni_{0.72}Pt_{0.28}-carbon nanotube hybrid catalyst. Referring to FIG. 2, a lattice of Ni_{0.72}Pt_{0.28} transition metal having a certain lattice spacing may be observed.

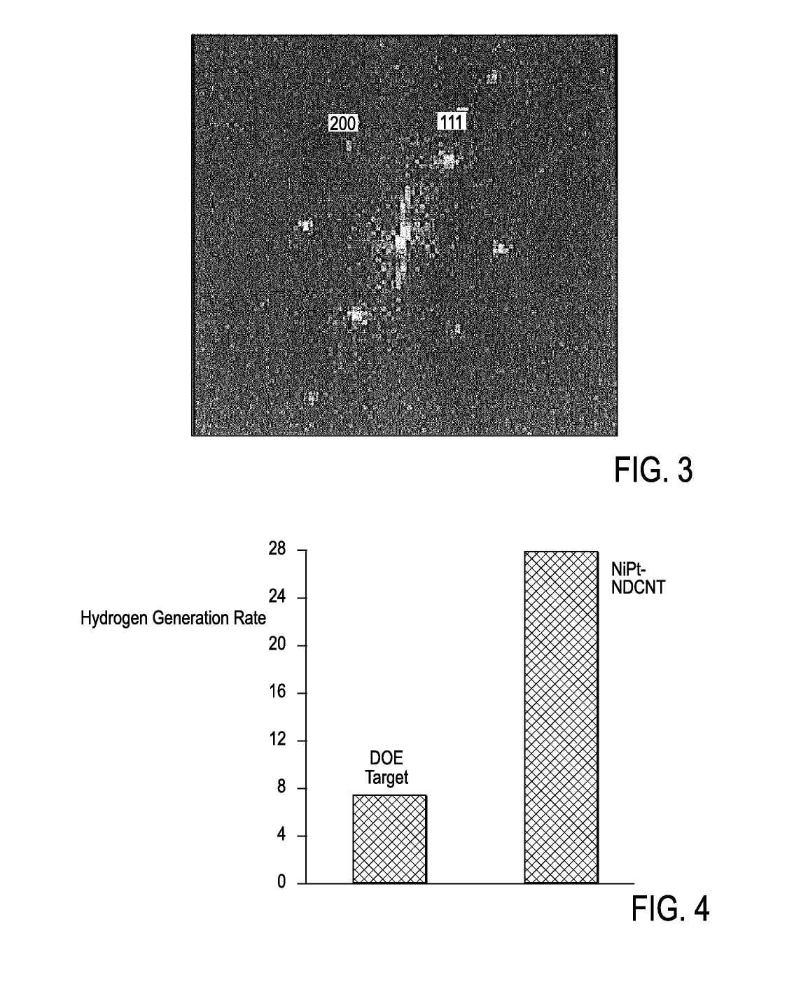

FIG. 3 illustrates lattice points obtained by Fourier transformation of the Ni_{0.72}Pt_{0.28} transition metal lattice of the inventive Ni_{0.72}Pt_{0.28}-carbon nanotube hybrid catalyst. Each numerical number shown in FIG. 3 means a lattice plane index for calculation of a lattice spacing and an angle of the lattice.

### Example 1

### Amount of Hydrogen Generated Per Minute

An amount of hydrogen per minute generated from an aqueous NH₃BH₃ solution by the inventive double metal-carbon nanotube hybrid catalyst (often abbrev. to “NiPt-NDCNT”), that is, a hydrogen generation rate was determined and compared to a target amount of hydrogen according to the US Department of Energy (DOE) (often abbrev. to “DOE Target”). Results thereof are shown in FIG. 4.

For this purpose, a temperature of 0.5 wt. % NH₃BH₃ in 50 mL of aqueous solution was set to 25° C. and 10 mg of the Ni_{0.72}Pt_{0.28}-carbon nanotube hybrid catalyst prepared in Preparative Example 2 was added to the above solution. An amount of hydrogen generated from the prepared mixture was measured using a gas flow meter.

Referring to FIG. 4, it can be seen that the inventive double metal-carbon nanotube hybrid catalyst generates hydrogen considerably more than the DOE target.

### Example 2

### Hydrogen Generation Speed Depending on Temperature

A speed of generating hydrogen from an aqueous NH₃BH₃ solution by the inventive double metal-carbon nanotube hybrid was measured with different temperatures.

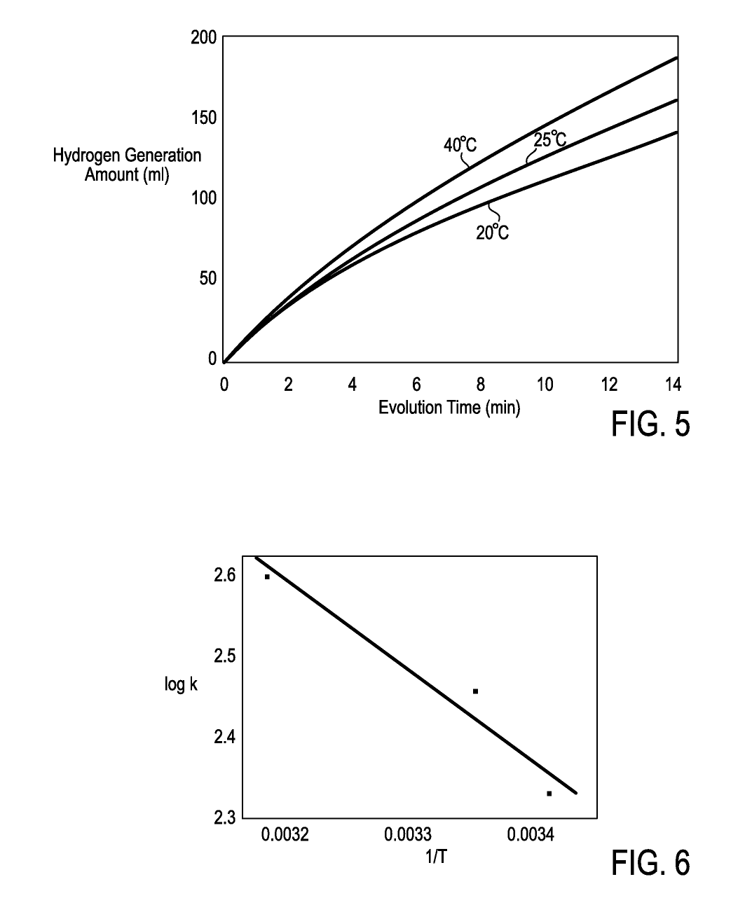

For this purpose, a temperature of 0.5 wt. % NH₃BH₃ in 50 mL of aqueous solution was set to 20° C., 25° C. and 40° C., respectively, and 10 mg of the Ni_{0.72}Pt_{0.28}-carbon nanotube hybrid catalyst prepared in Preparative Example 2 was added to each of the above solutions. A hydrogen generation amount along evolution time was measured using a gas flow meter and results thereof are shown in FIG. 5.

Referring to FIG. 5, it can be seen that the hydrogen generation speed of the Ni_{0.72}Pt_{0.28}-carbon nanotube hybrid catalyst according to the present invention increases as the temperature is elevated.

### Example 3

### Hydrogen Generation Speed Depending on Temperature

FIG. 6 illustrates an Arrhenius plot drawn up based on hydrogen generation characteristics of the Ni_{0.72}Pt_{0.28}-carbon nanotube hybrid catalyst prepared in Preparative Example 2 depending on temperature.

Applying the Arrhenius plot in FIG. 6 as well as the following Arrhenius equation, an activation energy of the inventive Ni_{0.72}Pt_{0.28}-carbon nanotube hybrid catalyst was calculated to be 9.7 kJ/mol.

Arrhenius Equation: ln k=ln A−Ea/RT

wherein k is a rate constant, A is a frequency factor, Ea is an activation energy, R is a gas constant, and T is a Kelvin temperature (K).

### Comparative Example 1

### Diffraction Angle

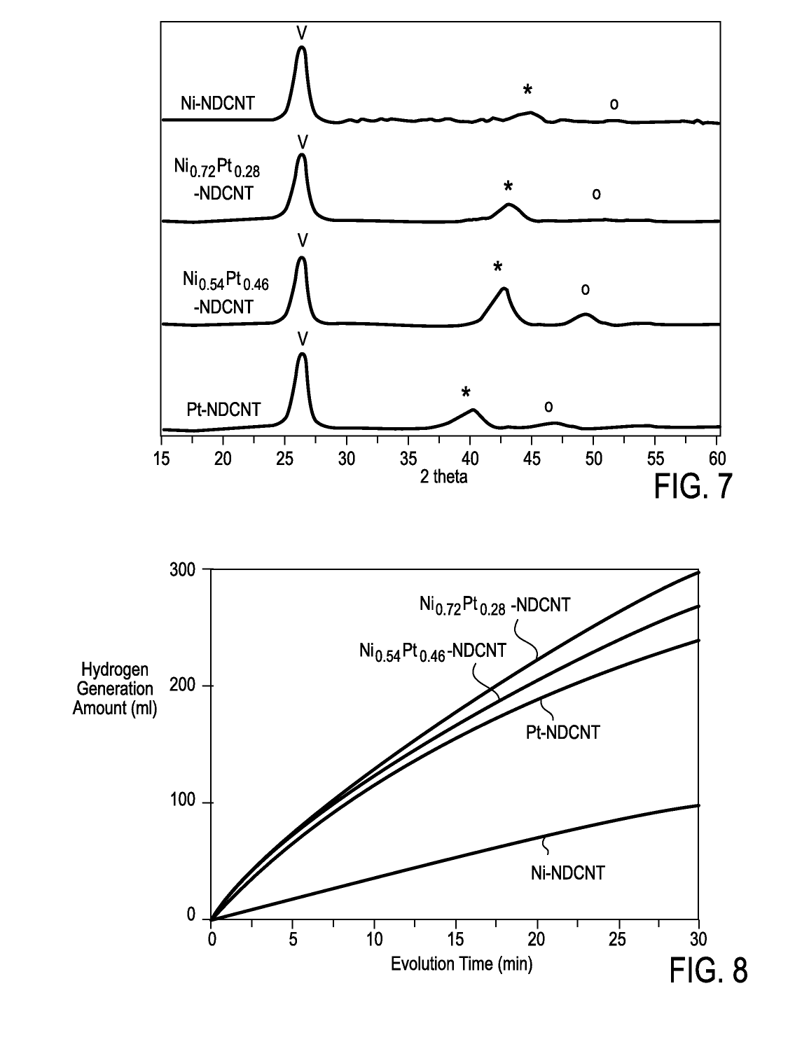

FIG. 7 is an X-ray diffraction analysis photograph illustrating the double metal-carbon nanotube hybrid catalyst of the present invention. The double metal-carbon nanotube hybrid catalyst was prepared by a procedure in Preparative Example 2, provided that a mixing ratio of transition metal salts was varied as shown in the following Table 1. Samples 2 and 3 are both the double metal-carbon nanotube hybrid catalysts according to the present invention, while each of samples 1 and 4 is a transition metal-carbon nanotube hybrid catalyst containing only one transition metal as a control.

TABLE 1

| | | Real ratio by | |
|---|---|---|---|
| | 10 mM | volume (result | |
| | NiCl₂•4H₂O:10 mM | of Inductive | |
| | H₂PtCl₆•4H₂O | Coupled Plasma | Indication |
| | (mL) | analysis) | in FIG. 7 |
| Sample 1 | 8:0 | 1:0 | Ni-NDCNT |
| Sample 2 | 7:1 | 0.72:0.28 | Ni_{0.72}Pt_{0.28}- |
| | | | NDCNT |
| Sample 3 | 6:2 | 0.54:0.46 | Ni_{0.54}Pt_{0.46}- |
| | | | NDCNT |
| Sample 4 | 0:8 | 0:1 | Pt-NDCNT |

From the X-ray diffraction analysis photograph of FIG. 7, it can be seen that the lattice spacing is increased with increased Pt content, in turn, reducing a diffraction angle (2-theta).

### Comparative Example 2

### Hydrogen Generation Speed

A speed of generating hydrogen from an aqueous NH₃BH₃ solution by the inventive double metal-carbon nanotube hybrid was measured.

For this purpose, a temperature of 0.5 wt. % NH₃BH₃ in 50 mL of aqueous solution was set to 25° C., and 10 mg of each of the samples 1 to 4 prepared in Comparative Example 1 was added to the above solution. A hydrogen generation amount in relation to evolution time was measured using a gas flow meter and results thereof are shown in FIG. 8.

Referring to FIG. 8, it can be seen that the Ni_{0.72}Pt_{0.28}-NDCNT (sample 2) and the Ni_{0.54}Pt_{0.46}-NDCNT (sample 3) exhibited relatively high hydrogen generation speed, compared to the controls, that is, Ni-NDCNT (sample 1) and Pt-NDCNT (sample 4).

The major reason for such excellent hydrogen generation characteristics such as high hydrogen generation speed is that the double metal-carbon nanotube hybrid catalyst of the present invention comprises at least two different transition metals, instead of a single transition metal.

Although the present invention has been described in detail with reference to its presently preferred embodiment, it will be understood by those skilled in the art that various modifications and equivalents can be made without departing from the spirit and scope of the present invention, as set forth in the appended claims. Also, the substances of each constituent explained in the specification can be easily selected and processed by those skilled in the art from the well-known various substances. Also, those skilled in the art can remove a part of the constituents as described in the specification without deterioration of performance or can add constituents for improving the performance. Furthermore, those skilled in the art can change the order to methodic steps explained in the specification according to environments of processes or equipments. Thus, it is intended that the present invention covers the modifications and variations of this invention provided they come within the scope of the appended claims and their equivalents.

What is claimed is:

1. A double metal-carbon nanotube hybrid catalyst comprising at least two of transition metals selected from a group consisting of Mn, Fe, Co, Ni, Cu, Mo, Tc, Ru, Rh, Pd, Ag, Re, Os, Ir and Pt which are distributed in the catalyst.

2. A method for preparation of a double metal-carbon nanotube hybrid catalyst, comprising:
adding nitrogen doped carbon nanotube (NDCNT) to a polyol solution to prepare a carbon nanotube solution;
adding at least two of transition metal salts as well as sodium borohydride (NaBH₄) to the prepared carbon nanotube solution to return the carbon nanotube by reduction thereof; and
thermally treating the reduced carbon nanotube under hydrogen atmosphere after vacuum drying the same, so as to form the double metal-carbon nanotube hybrid catalyst.

3. The method according to claim 2, wherein the NDCNT is prepared by plasma CVD using a gas mixture containing a hydrocarbon gas and a nitrogen gas in a ratio (%) by volume of 1:99 to 99:1 in the presence of a metal catalyst.

4. The method according to claim 2, wherein the NDCNT is a carbon nanotube containing nitrogen in the range of 0.1 to 20 at %.

5. The method according to claim 2, wherein the polyol includes at least one selected from a group consisting of ethyleneglycol, diethyleneglycol, polyethyleneglycol, 1,2-propandiol and dodecane alone or in combination with two or more thereof.

6. The method according to claim 2, wherein a transition metal in the NDCNT is at least one selected from a group consisting of Mn, Fe, Co, Ni, Cu, Mo, Tc, Ru, Rh, Pd, Ag, Re, Os, Ir and Pt.

7. The method according to claim 2, wherein anions contained in the transition metal salt is acetate or chloride.
